(19) United States
(12) Patent Application Publication
(10) Pub. No.: US 2018/0297889 A1
(43) Pub. Date: Oct. 18, 2018

(54) REMOVABLE GLASS SURFACE TREATMENTS AND METHODS FOR REDUCING PARTICLE ADHESION

(71) Applicant: Corning Incorporated, Corning, NY (US)

(72) Inventors: James Patrick Hamilton, Horseheads, NY (US); Jenny Kim, Horseheads, NY (US); James Robert Matthews, Painted Post, NY (US); Kouta Nakamura, Shizuoka (JP); Louis Joseph Stempin, Jr., Corning, NY (US); Wanda Janina Walczak, Big Flats, NY (US)

(21) Appl. No.: 15/765,406

(22) PCT Filed: Sep. 29, 2016
(86) PCT No.: PCT/US16/54264

§ 371 Date: Apr. 2, 2018

Related U.S. Application Data
(60) Provisional application No. 62/236,375, filed on Oct. 2, 2015.

(51) Int. Cl. C03C 17/30; C03C 17/32

(52) U.S. Cl. CPC C03C 17/30; C03C 17/32; C03C 2218/32; C03C 2217/75; C03C 2217/76

(57) ABSTRACT

Disclosed herein are methods for treating a glass substrate, comprising bringing a surface of the glass substrate into contact with at least one surface treatment agent for a time sufficient to form a coating comprising the at least one surface treatment agent on at least a portion of the surface. Also disclosed herein are glass substrates comprising at least one surface and a coating on at least a portion of the surface, wherein the coated portion of the surface has a contact angle ranging from about 20 degrees to about 95 degrees, and/or a contact angle greater than about 20 degrees after contact with water, and/or a contact angle less than about 10 degrees after wet or dry cleaning of the glass substrate.

This application claims the benefit of priority under 35 U.S.C. § 119 of U.S. Provisional Application Ser. No. 62/236,375 filed on Oct. 2, 2015, the content of which is relied upon and incorporated herein by reference in its entirety.

### FIELD OF THE DISCLOSURE

Disclosed herein are methods for treating a glass substrate to reduce the adhesion of particles to a surface of the glass substrate and, more particularly, to glass surface treatments with improved resistance to contamination and improved ease of removability.

### BACKGROUND

Consumer demand for high-performance display devices, such as liquid crystal and plasma displays, has grown markedly in recent years due to the exceptional display quality, decreased weight and thickness, low power consumption, and increased affordability of these devices. Such high-performance display devices can be used to display various kinds of information, such as images, graphics, and text. High-performance display devices typically employ one or more glass substrates. The surface quality requirements for glass substrates, such as surface cleanliness, have become more stringent as the demand for improved resolution and image performance increases. The surface quality may be influenced by any of the glass processing steps, from forming the substrate to storage to final packaging.

Glass surfaces can have a high surface energy, due in part to the presence of surface hydroxyls (X—OH, X=cation), e.g., silanol (SiOH), on the glass surface. Surface hydroxyls can quickly form when the glass surface comes into contact with moisture in the air. Hydrogen bonding between the surface hydroxyl groups can induce further moisture absorption which can, in turn, lead to a viscous, hydrated layer comprising molecular water on the glass surface. Such a viscous layer can have various detrimental effects including, for example, a “capillary” effect that may induce stronger adhesion of particles on the glass surface and/or condensation of surface hydroxyls to form covalent oxygen bonds which can lead to stronger adhesion of particles to the surface, particularly at higher temperatures.

Glass substrates with high surface energy can attract particulates in the air during shipping, handling, and/or manufacturing. In addition, strong adhesion forces can lead to covalent bonding between the particles and the glass during storage, which can, in turn, result in decreased yield during the finishing and cleaning processes. Various potential methods for protecting against particle adhesion can include, for example, thermal evaporation, spray methods, lamination, or the use of coating transfer paper. In some instances, glass may be coated with a Visqueen film and/or with interleaf paper and packed in a crate or other storage container, such as a DensePak crate. The storage containers may be retained in warehouses for several months, e.g., 2-3 months, in an uncontrolled environment. However, the longer a glass substrate has been stored, e.g., for several months, the harder it is to remove the particles from the surface due to potential covalent bonding between the particles and the glass surface.

In the case of unprotected glass, the uncontrolled warehouse environment can provide continuous opportunity for organic contaminants to land on the glass surface, which may lead to adhesion, reduced cleanliness, and/or potential staining. When interleaf paper is placed between glass substrates, vibration during transportation may cause shedding of cellulosic particles from the paper, which may subsequently adhere to the glass surface. On the other hand, protecting glass substrates with a Visqueen film may reduce the potential for environmental and/or cellulosic contamination, but contact with the film material for extended periods of time, particularly in hot and/or humid environments, may cause transfer of organic slip agents (e.g., erucamide) from the film to the glass surface. Such organic residues can be difficult to remove using traditional washing processes and/or can result in staining of the glass substrate.

Current methods for protecting against particle adhesion can thus be unreliable and/or inconsistent and can prove difficult and/or impractical to integrate into the glass finishing process. Other disadvantages may include increased manufacturing cost and/or complexity, e.g., due to expensive materials and/or extra processing steps such as lamination. Certain surface treatments may also be difficult to remove when the end user seeks to clean and utilize the glass product and/or may be too easily removed during finishing processes preceding storage.

Accordingly, it would be advantageous to provide methods for reducing particle adhesion on a glass substrate that remedy one or more of the above deficiencies, e.g., methods that are more economical, practical, and/or more easily integrated into current glass forming and finishing processes. In some embodiments, the methods disclosed herein can be used to produce glass substrates that have low surface energy, high contact angle, and improved handling and/or storage properties, such as reduced particle adhesion over a given storage time.

### SUMMARY

The disclosure relates, in various embodiments, to methods for treating a glass substrate, the methods comprising bringing a surface of the glass substrate into contact with at least one surface treatment agent for a time sufficient to form a coating on at least a portion of the surface, wherein a coated portion of the surface has a contact angle with deionized water ranging from about 20 degrees to about 95 degrees, wherein after contact with water the coated portion has a contact angle of greater than about 20 degrees, and wherein after contact with a detergent solution the coated portion has a contact angle of less than about 10 degrees. Also disclosed herein are glass substrates comprising at least one surface and a coating on at least a portion of the surface, wherein the coated portion of the surface has a contact angle with deionized water ranging from about 20 degrees to about 95 degrees, wherein after contact with water the coated portion has a contact angle of greater than about 20 degrees, and wherein after contact with a detergent solution the coated portion has a contact angle of less than about 10 degrees.

According to various embodiments, the at least one surface treatment agent can be chosen from surfactants, polymers, and fatty chain functional organic compounds, e.g., hydrophobic polymers, hydrophilic/hydrophobic copolymers, non-ionic surfactants, cationic surfactants comprising a (C₈-C₃₀)alkyl chain, fatty alcohols comprising a (C₆-C₃₀)alkyl chain, and combinations thereof. The at least one surface treatment agent may be present in a solution comprising, for example, from about 0.1% to about 10% by weight of surface treatment agent. The thickness of the coating may, in some embodiments, be less than about 1 μm, such as less than about 100 nm, or even less than about 10 nm.

In certain embodiments, the coated portion of the surface can have a contact angle with deionized water greater than about 20 degrees after contact with water having a temperature ranging from about 25° C. to about 80° C. for a time period of about 5 minutes or less. The coated portion of the surface can have a contact angle with deionized water less than about 20 degrees after contact with a detergent solution having a temperature ranging from about 25° C. to about 80° C. for a time period of about 2 minutes or less. In further embodiments, after washing with detergent, the glass substrate may have a contact angle with deionized water of less than about 10 degrees.

Additional features and advantages will be set forth in the detailed description which follows, and in part will be readily apparent to those skilled in the art from that description or recognized by practicing the methods described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding, and are incorporated into and constitute a part of this specification. The drawings illustrate various non-limiting embodiments and together with the description serve to explain the principles and operations of the disclosure.

### BRIEF DESCRIPTION OF THE DRAWINGS

Various features, aspects and advantages of the present disclosure are better understood when the following detailed description is read with reference to the accompanying drawings wherein like structures are indicated with like reference numerals when possible, in which:

FIG. 1 is a graphical depiction of adhered glass particle density as a function of storage time;

FIG. 2 is a graphical depiction of particle count on a glass surface for various untreated and surface treated glass samples (normal resolution);

FIG. 3 is a graphical depiction of particle count on a glass surface for various untreated and surface treated glass samples (high resolution); and

FIG. 4 is a graphical depiction of particle removal efficiency for various untreated and surface treated glass samples

### DETAILED DESCRIPTION

Drawn or cleaned glass surfaces can have a very high surface energy (as high as 90 mJ/m² in some cases). Such high surface energy can increase the susceptibility of the surface to particle adsorption from the air. Without wishing to be bound by theory, it is believed that the high surface energy is due at least in part to the presence of surface hydroxyl groups (X—OH), e.g., SiOH, AlOH, and/or BOH, on the glass surface, which can form hydrogen bonds with available particles. In addition, if a particle such as a glass or oxide particle remains adhered to the surface, the initial hydrogen bonding adhesion and/or van der Waals forces may be enhanced by condensation which can then lead to stronger covalent bonding. Particles that are covalently bound to the surface of the glass substrate can be even more difficult to remove, resulting in lower finishing yields.

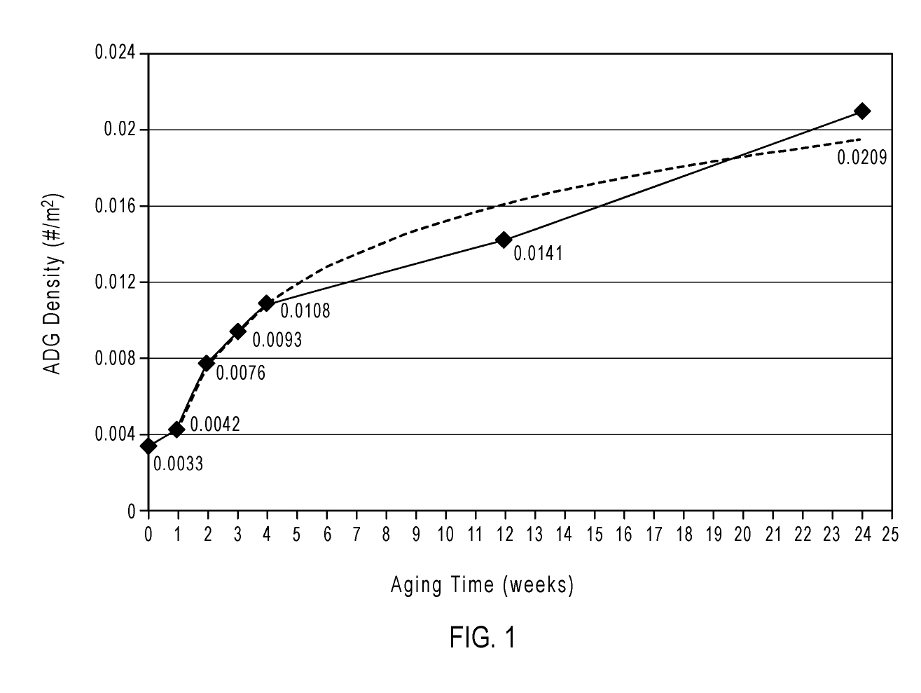

Glass particles of various sizes and shapes can be generated, e.g., by bottom-of-draw (BOD) traveling anvil machine (TAM) processing with either horizontal or vertical direction scoring and breaking, or by edge finishing, shipping, handling, and/or storage of the glass. In various industries, such particles may be referred to as adhered glass (ADG). Adhesion and/or adsorption of particles to the glass surface can increase over time and can vary depending on changes in atmospheric conditions, such as temperature, humidity, cleanliness of the storage environment, and the like. Glass in storage for more than 3 months can be particularly susceptible to particle adhesion by high energy (e.g., covalent) bonds and can be difficult, if not impossible, to finish to an acceptable level that meets stringent quality control guidelines. FIG. 1 demonstrates the density of ADG particles on a glass surface as a function of storage time. As shown in the plot, as storage time increases, the susceptibility of the substrate to particle adhesion noticeably increases.

Methods

Disclosed herein are methods for treating a glass surface to reduce or eliminate adhesion of particles to the glass surface. As used herein, the term “particle” and variations thereof is intended to refer to various contaminants of any shape or size adhered and/or adsorbed onto a glass surface. For instance, particles can include organic and inorganic contaminants, such as glass particles (e.g., ADG), cellulose fibers, dust, M-OX particles (M=metal; X=cation), and the like. Particles can be generated on the surface of a glass article during, e.g., the manufacture, transport, and/or storage of the glass article, such as during cutting, finishing, edge grinding, conveying (e.g., with suction cups, conveyor belts, and/or rollers), or storing (e.g., boxes, papers, etc.).

The methods disclosed herein comprise, for example, bringing a surface of the glass substrate into contact with at least one surface treatment agent for a residence time sufficient to form a coating on at least a portion of the surface, wherein a coated portion of the surface has a contact angle with deionized water ranging from about 20 degrees to about 95 degrees, after contact with water the coated portion of the surface has a contact angle with deionized water of greater than about 20 degrees, and after contact with a detergent solution the coated portion of the surface has a contact angle with deionized water of less than about 10 degrees.

According to various embodiments, the at least one surface treatment agent may serve as chemical and/or physical barriers that can prevent organic and inorganic contaminants from landing on the glass surface and/or from forming a bond with the glass surface during storage. Treatment methods disclosed herein can, in some embodiments, neutralize at least a portion of surface hydroxyl groups (X—OH) that may be present on the glass surface, e.g., rendering them unavailable to react with particles or other potential reactants. Neutralization can occur by chemisorption, such as covalent and ionic bonding, or by physisorption, such as hydrogen bonding and van der Waals interaction. According to various embodiments, the treatment methods disclosed herein can neutralize at least about 50% of surface hydroxyl groups, such as greater than about 60%, greater than about 70%, greater than about 80%, greater than about 90%, greater than about 95%, or greater than about 99%, e.g., ranging from about 50% to about 100%, including all ranges and subranges therebetween.

The efficacy of a coating may be evaluated, for example by (a) whether or not the coating resists unwanted removal (e.g., by water at room temperature or slightly elevated temperatures), (b) whether or not the coating can be effectively removed by intentional washing (e.g., by an alkaline detergent at elevated temperatures), and (c) whether or not the coating reduces the amount of adhered particles relative to an untreated control. Potential surface treatment agents can be divided into four categories: water-soluble agents, organic-soluble agents, surface-reactive agents, and surface-passive agents. Each category may have its advantages or disadvantages with respect to properties (a)-(c) outlined above and/or other processing considerations.

For example, water-soluble agents may be environmentally friendly, safer, and/or less toxic, but these agents may not resist unwanted removal, e.g., during an aqueous edge grinding process. Organic-soluble agents may exhibit higher resistance to removal by water, but may also complicate processing due to flammability and/or toxicity issues. Similarly, surface-reactive agents may bond (e.g., chemisorb) more strongly to the glass surface and may therefore provide stable coatings that resist unwanted removal and/or improve the resistance of the glass to particle adhesion. However, coatings employing such surface-reactive agents may be difficult to remove, thereby lengthening and/or complicating the downstream processing of the glass substrate. On the other hand, coatings comprising surface-passive agents may be easier to wash off with detergent solutions, but may not bind (e.g., physisorb) strongly enough to the glass surface to resist unwanted removal by water during intervening processing steps.

Without wishing to be bound by theory, it is believed that surface treatment agents that result in a coating having a relatively higher hydrophobicity may have improved resistance to particle adhesion and may therefore reduce the number of particles to be washed off the glass surface and/or facilitate the removal of any such adhered particles. A lower surface energy and, particularly, a lower polar surface energy component, can, in some embodiments, be indicative of a more hydrophobic surface. Polarity of the glass surface can be affected, e.g., by the concentration of hydroxyl groups on the glass surface.

By neutralizing at least a portion of the surface hydroxyl groups on the glass surface, the at least one surface treatment agent can reduce the overall surface energy of the glass substrate to less than about 65 mJ/m², such as less than about 60 mJ/m², less than about 55 mJ/m², less than about 50 mJ/m², less than about 45 mJ/m², less than about 40 mJ/m², less than about 35 mJ/m², less than about 30 mJ/m², or less than about 25 mJ/m², e.g., ranging from about 25 mJ/m² to about 65 mJ/m², including all ranges and subranges therebetween. The polar surface energy can be, for example, less than about 25 mJ/m², such as less than about 20 mJ/m², less than about 15 mJ/m², less than about 10, less than about 9, less than about 8, less than about 7, less than about 6, less than about 5, less than about 4, less than about 3, less than about 2, or less than about 1 mJ/m², e.g., ranging from about 1 mJ/m² to about 25 mJ/m², including all ranges and subranges therebetween. The dispersive energy of the coated portion can, in certain embodiments, be greater than about 10 mJ/m², such as greater than about 15 mJ/m², greater than about 20 mJ/m², greater than about 25 mJ/m², greater than about 30 mJ/m², greater than about 35 mJ/m², or greater than about 40 mJ/m², e.g., ranging from about 10 mJ/m² to about 40 mJ/m², including all ranges and subranges therebetween.

Surface tension (or surface energy) of a material can be determined by methods well known to those in the art including the pendant drop method, the du Nuoy ring method or the Wilhelmy plate method (Physical Chemistry of Surfaces, Arthur W. Adamson, John Wiley and Sons, 1982, pp. 28). Moreover, the surface energy of a material surface can be broken down into polar and nonpolar (dispersive) components by probing surfaces with liquids of known polarity such as water and diiodomethane and determining the respective contact angle with each probe liquid. Accordingly, one can determine the surface properties of an untreated (control) glass substrate as well as the surface properties of a treated glass substrate by measuring, e.g., water and diiodomethane control angles of each substrate using any one of the surface tension methods described above, alone or in conjunction with the following formula:

σ_{T}=σ_{D}+σ_{P},

where σ_{T} is the overall surface energy, σ_{D} is the dispersive surface energy, and σ_{P} is the polar surface energy.

Hydrophobicity of a surface can also be indicated by a higher contact angle of the surface with deionized water. Higher contact angles tend to indicate that the surface is not easily wet by water and is thus more water-resistant. Without wishing to be bound by theory, it is believed that this water resistance can prevent glass or other particles from forming a strong bond with the glass surface and/or may facilitate subsequent removal of particulate or organic contaminants by traditional washing methods. According to various embodiments, after contact with the surface treatment agent, the coated portion of the glass may have a contact angle with deionized water ranging from about 20 degrees to about 95 degrees, such as from about 30 degrees to about 90 degrees, from about 40 degrees to about 85 degrees, from about 50 degrees to about 80 degrees, or from about 60 degrees to about 70 degrees, including all ranges and subranges therebetween.

Hydrophobicity, or water resistance, may also be demonstrated by a relatively high contact angle of the treated substrates, even after washing with deionized water for 5 minutes or less. The coating comprising the at least one surface treatment agent may, in some embodiments, exhibit a moderate resistance to removal by water alone, which can be useful if the coated substrate is to be subjected to various finishing steps, such as edge finishing or edge cleaning, before its end use. As such, in these embodiments, the contact angle of the coated surface (with deionized water), after contact with water (e.g., at a temperature ranging from about 25° C. to about 80° C., for a period of up to about 5 minutes), may be greater than about 20 degrees, such as greater than about 25, 30, 35, 40, 45, 50, 55, 60, 65, 70, 75, 80, 85, 90, or 95 degrees, e.g., ranging from about 20 to about 95 degrees, including all ranges and subranges therebetween. In some embodiments, the period of contact with water can range from about 15 seconds to about 5 minutes, such as from about 30 seconds to about 4 minutes, from about 60 seconds to about 3 minutes, or from about 90 seconds to about 2 minutes, including all ranges and subranges therebetween. Likewise, the temperature of the water can range from about 25° C. to about 80° C., such as from about 30° C. to about 70° C., from about 35° C. to about 60° C., or from about 40° C. to about 50° C., including all ranges and subranges therebetween.

The glass substrate may be contacted with the at least one surface treatment agent for a period of time sufficient to coat at least a portion of the glass surface with the agent. In certain embodiments, the entire glass surface can be coated with the at least one surface treatment agent. In other embodiments, desired portions of the glass surface can be coated, such as, for example, the edges or perimeter of the glass substrate, the central region, or any other region or pattern as desired, without limitation.

As used herein, the terms “contact” and “contacted” and variations thereof are intended to denote the physical interaction of the glass surface with the at least one surface treatment agent. As a result of the physical contact of the glass surface with the at least one surface treatment agent, a bond may form between the at least one surface treatment agent and the glass surface, e.g., with at least one surface hydroxyl group. Such bonds can be covalent bonds, ionic bonds, hydrogen bonds, and/or van der Waals interactions, to name a few.

Contact between the at least one surface treatment agent and the glass surface can be achieved using any suitable method known in the art, for example, spray coating, dip coating, meniscus coating, flood coating, brush coating, roller coating, and the like. In certain embodiments, the at least one surface treatment agent may be applied by spray coating, e.g., in a spraying station as the glass substrate moves along a production line in the manufacturing process. The spray coating may be airless or air-assisted or, in additional embodiments, an aerosol may be employed to create a fog of the surface treatment agent. In some embodiments, the surface treatment agent may be deposited as a liquid or vapor on the glass surface. According to further embodiments, the glass substrate may be transported using a continuous horizontal or vertical conveyance system, and a spraying station may be located at any point along the conveyance system.

The temperature of the glass substrate at the time of coating can vary depending upon the point during the manufacturing process at which the coating is applied. For instance, the coating may be applied during or after the bottom of draw (BOD) process, which can include the travelling anvil machine (TAM), which scores and breaks the glass into sheets, and the vertical bead score-and-break separation (VBS) process. In some embodiments, the coating step may be incorporated into the BOD process, e.g., after VBS. Glass surface temperatures in the BOD area may range up to about 300° C.; however, after VBS the glass surface temperatures may be lower, such as less than or equal to about 100° C. While conventional, thicker (e.g., >1 μm) coatings are often applied to hot glass surfaces prior to VBS processing, the coatings disclosed herein may be applied after VBS to cooler glass surfaces. For example, the glass surface temperature may range from about 10° C. to about 100° C., such as from about 20° C. to about 90° C., from about 30° C. to about 80° C., from about 40° C. to about 70° C., or from about 50° C. to about 60° C., including all ranges and subranges therebetween.

The residence time, e.g. time period during which the at least one surface treatment agent contacts the glass surface can vary, e.g., depending on the desired coating properties. By way of a non-limiting example, the residence time can range from less than a second to several minutes, such as from about 1 second to about 10 minutes, from about 5 seconds to about 9 minutes, from about 10 seconds to about 8 minutes, from about 15 seconds to about 7 minutes, from about 20 seconds to about 6 minutes, from about 30 seconds to about 5 minutes, from about 1 minute to about 4 minutes, or from about 2 minutes to about 3 minutes, including all ranges and subranges therebetween. In various embodiments, a single coat of the at least one surface treatment agent may be applied to the glass surface or, in other embodiments, multiple coats may be applied, such as 2 or more, 3 or more, 4 or more, or 5 or more coats, and so on. For example, the glass substrate may be dipped once or more than once in a solution comprising the at least one surface treatment agent, or the glass substrate may be sprayed with the surface treatment agent using a single pass or multiple passes.

The residence time may also depend on the desired thickness of the coating. In some non-limiting embodiments, the coating may have a thickness of less than about 1 μm, such as less than about 900 nm, 800 nm, 700 nm, 600 nm, 500 nm, 400 nm, 300 nm, 200 nm, 100 nm, 10 nm or less, e.g., ranging from about 1 nm to about 100 nm, from about 2 nm to about 90 nm, from about 3 nm to about 80 nm, from about 5 nm to about 70 nm, from about 10 nm to about 60 nm, from about 20 nm to about 50 nm, or from about 30 nm to about 40 nm, including all ranges and subranges therebetween. Without wishing to be bound by theory, it is believed that thinner layers, e.g., self-assembled monolayers, may be easier to remove using traditional washing techniques and shorter washing times. Thinner coatings may also have the added advantages of reduced material waste, faster deposition times, and/or reduced impact upon the environment.

According to various embodiments, the surface treatment agent may be incorporated into a solution comprising one or more solvents. The concentration of the surface treatment agent in such solutions may range, in some embodiments, from about 0.1 wt % to about 10 wt %, such as from about 0.25 wt % to about 9 wt %, from about 0.5 wt % to about 8 wt %, from about 1 wt % to about 7 wt %, from about 1.5 wt % to about 6 wt %, from about 2 wt % to about 5 wt %, or from about 3 wt % to about 4 wt %, including all ranges and subranges therebetween. Suitable solvents can include, by way of non-limiting example, water, deionized water, alcohols (such as methanol, ethanol, n-propanol, isopropanol, butanol, and the like), volatile hydrocarbons (such as C₁₋₁₂ hydrocarbons and mixtures thereof, e.g., naptha), water-miscible organic solvents (such as dimethylformamide, dimethylsulfoxide, and N-methyl-2-pyrrolidone), and mixtures thereof. Such solvents may be evaporated from the surface after deposition, e.g., by heating or otherwise drying the surface, or by natural evaporation at ambient conditions. Alternatively, in the case of vapor deposition of the at least one surface treatment agent, a solvent may not be used and the treatment agent itself may be vaporized and contacted with the glass surface.

The methods disclosed herein may, in non-limiting embodiments, provide glass surface treatments that exhibit improved resistance to particle adhesion and/or improved removability of such particles from the glass surface. For instance, the removal efficiency for particles adhered to the glass surface after washing with a detergent can be at least about 50%, such as greater than about 60%, greater than about 70%, greater than about 80%, greater than about 90%, greater than about 95%, or greater than about 99%, e.g., ranging from about 50% to about 99%, including all ranges and subranges therebetween. Exemplary washing techniques can include washing with a mild detergent solution such as alkaline detergent solutions, for a time period ranging from about 15 seconds to about 2 minutes, such as from about 20 seconds to about 90 seconds, from about 30 seconds to about 75 seconds, or from about 45 seconds to about 60 seconds, including all ranges and subranges therebetween.

An exemplary commercially available detergent may include, but is not limited to, SemiClean KG. For example, solutions of detergent in water may have concentrations of less than about 10% by volume, e.g., ranging from about 1% to about 10%, from about 2% to about 9%, from about 3% to about 8%, from about 4% to about 7%, or from about 5% to about 6% by volume. Non-limiting washing temperatures can range, for instance, from about 25° C. to about 80° C., such as from about 30° C. to about 70° C., from about 35° C. to about 60° C., or from about 40° C. to about 50° C., including all ranges and subranges therebetween.

Prior to contact with the surface treatment agent, the glass substrate can be processed using one or more optional steps, such as polishing, finishing, and/or cleaning the surface(s) or edge(s) of the glass substrate. Likewise, after contact with the surface treatment agent, the glass substrate can be further processed by these optional steps. Such additional steps can be carried out using any suitable methods known in the art. For instance, exemplary glass cleaning steps can include dry or wet cleaning methods. Cleaning steps can, in some embodiments, be carried out using alkaline detergent (e.g., Semi Clean KG), SC-1, UV ozone, and/or oxygen plasma, to name a few. Furthermore, after contacting the glass surface with the at least one surface treatment agent, the glass substrate may be optionally further processed, e.g., to apply a polyethylene film (Visqueen) to further protect the glass sheet. Of course, the coating between the glass surface and the Visqueen film, if present, can protect against the transfer of organic compounds from the film onto the glass surface.

The coated glass substrate may, in some embodiments, be subjected to various finishing steps, such as edge finishing or edge cleaning processes. As such, in these embodiments, it may be desirable for the surface treatment to resist removal by water alone, e.g., as evidenced by little or no decrease in the contact angle of the surface with deionized water, as discussed in more detail above. Additionally, it may be desirable for the surface treatment to be easily removable with a detergent or using other cleaning steps outlined above, e.g., as evidenced by a decrease in contact angle with deionized water below about 10 degrees, such as below about 8 degrees, or below about 5 degrees, e.g., ranging from about 1 to about 10 degrees. Of course, the treated glass substrates may or may not exhibit one or all of these properties but are still intended to fall within the scope of the instant disclosure.

Glass Substrates

The disclosure also relates to glass substrates produced using the methods disclosed herein. For example, the glass substrates can comprise at least one surface, wherein at least a portion of the surface is coated with a layer comprising at least one surface treatment agent, wherein the coated portion of the surface has a contact angle with deionized water ranging from about 20 to about 95 degrees. In additional embodiments, after contacting the glass substrate with water, the coated portion of the surface can have a contact angle with deionized water of greater than about 20 degrees. In further embodiments, after contacting the glass substrate with a detergent solution, the coated portion of the surface can have a contact angle with deionized water of less than about 10 degrees.

The glass substrate may comprise any glass known in the art including, but not limited to, aluminosilicate, alkali-aluminosilicate, alkali-free alkaline earth aluminosilicate, borosilicate, alkali-borosilicate, alkali-free alkaline earth borosilicate, aluminoborosilicate, alkali-aluminoborosilicate, alkali-free alkaline earth aluminoborosilicate, and other suitable glasses. In certain embodiments, the glass substrate may have a thickness of less than or equal to about 3 mm, for example, ranging from about 0.1 mm to about 2.5 mm, from about 0.3 mm to about 2 mm, from about 0.7 mm to about 1.5 mm, or from about 1 mm to about 1.2 mm, including all ranges and subranges therebetween. Non-limiting examples of commercially available glasses include, for instance, EAGLE XG®, Iris™, Lotus™, Willow®, and Gorilla® glasses from Corning Incorporated.

In various embodiments, the glass substrate can comprise a glass sheet having a first surface and an opposing second surface. The surfaces may, in certain embodiments, be planar or substantially planar, e.g., substantially flat and/or level. The glass substrate can be substantially planar or two-dimensional and, in some embodiments, can also be non-planar or three-dimensional, e.g., curved about at least one radius of curvature, such as a convex or concave substrate. The first and second surfaces may, in various embodiments, be parallel or substantially parallel. The glass substrate may further comprise at least one edge, for instance, at least two edges, at least three edges, or at least four edges. By way of a non-limiting example, the glass substrate may comprise a rectangular or square glass sheet having four edges, although other shapes and configurations are envisioned and are intended to fall within the scope of the disclosure. According to various embodiments, the glass substrate may have a high surface energy prior to treatment, such as up to about 75 mJ/m² or more, e.g., ranging from about 80 mJ/m² to about 100 mJ/m².

The glass substrate can be coated with a layer comprising at least one surface treatment agent as described above with reference to the methods disclosed herein. The coating or layer can comprise any suitable surface treatment agent capable of improving the resistance of the surface to particle adhesion, resisting unwanted removal by water alone, and/or being effectively and/or quickly removed by traditional washing techniques. Exemplary surface treatment agents can include, but are not limited to, surfactants, polymers, silanes, fatty chain functional organic compounds, and combinations thereof.

Fatty chain functional organic compounds can include a fatty alkyl chain and a functional group. The functional group may be polar in character and may therefore be attracted to the hydrophilic glass surface, such that the compound orients itself with the fatty alkyl portion extending away from the glass surface to serve as a hydrophobic barrier to particle adhesion. The functional group(s) of the fatty chain may include, but are not limited to, amines, alcohols, epoxies, acids, and siloxanes. As such, in some embodiments, the fatty chain functional organic compounds may be chosen from (C₆-C₃₀)alkyl amines, alcohols, epoxies, acids, and siloxanes. Exemplary (C₆-C₃₀)alkyl acids can include, but are not limited to, carboxylic acids, organic sulfonic acids, and organic phosphonic acids, to name a few. Non-limiting examples of (C₆-C₃₀) fatty alcohols can include, for instance, octanol, decanol, dodecanol, hexadecanol, octadecanol, and the like.

As used herein, the term “siloxane” is intended to refer to a group of formula —Si(R¹)₃₋ₙ(OR²)ₙ, wherein R¹ is an alkyl or lower alkyl, R² is a lower alkyl, and n is equal to 1, 2, or 3. As used herein, the term “alkyl” is intended to denote a linear or branched saturated hydrocarbon comprising from 1 to 30 carbon atoms, such as methyl ethyl, n-propyl, isopropyl, n-butyl, isobutyl, t-butyl, pentyl, hexyl, heptyl, octyl, decyl, tetradecyl, hexadecyl, octadecyl, eicosyl, tetracosyl, and the like. A “lower alkyl” group is intended to refer to an alkyl group containing from 1 to 5 carbon atoms ((C₁-C₅)alkyl group), e.g., methyl ethyl, n-propyl, isopropyl, n-butyl, isobutyl, t-butyl, and pentyl.

According to various embodiments, the fatty chain functional organic compounds may be chosen from fatty alcohols, such as octadecanol. While fatty alcohols may be only weakly bound to the glass surface by hydrogen bonding of the alcohol hydroxyl to the glass surface hydroxyls, such alcohols may also resist washing off when contacted by water alone due to their low solubility in water. However, in the presence of a detergent, such fatty alcohols may be removed with relative speed and ease. Another benefit associated with fatty chain functional organic compounds, such as fatty alcohols, is the ability to deposit such agents in liquid or vapor form. For instance, fatty alcohols may be evaporated directly onto the glass surface in the absence of any solvents. Such a vaporization method can thus avoid a subsequent evaporation step in which the solvent is removed, as well as avoiding the need to dispose of any such solvent after use.

Surfactants may also be used as passive surface treatment agents, e.g., agents that do not covalently bond to the glass surface. Suitable surfactants may include those exhibiting ionic interactions with the glass surface, as these appear to be more stable non-covalent interactions, which can better resist unwanted removal by water during intervening process steps. Exemplary surfactants suitable for use as surface treatment agents include, but are not limited to, cationic surfactants comprising long (e.g., C₈-C₃₀) alkyl chains, such as dicocoalkyldimethylammonium chloride, didecyldimethylammonium chloride, dodecyltrimethylammonium chloride, and octadecyltrimethylammonium chloride to name a few. Further suitable surfactants may include, for example, non-ionic surfactants such as ethoxylated cocoamine, PEG/PPG copolymer non-ionic surfactant, and the like.

Surface-passive treatment agents may have some practical limitations. For example, water-soluble agents tend to not bond strongly enough to the glass surface to resist unwanted solubilization in water and, thus, removal during exposure to water. However, while agents that are not water-soluble may provide improved resistance to removal in water, such agents may also be difficult to deposit, e.g., requiring undesirable flammable and/or toxic organic solvents. Polymeric materials may serve as surface-passive treatment agents which may not have these drawbacks. For example, polymer materials may have multiple anchoring points (e.g., multiple hydrogen-bonding groups), which can raise the kinetic barrier of the coating to dissolution in water. At the same time, such polymers may be soluble or dispersible in water such that they can be deposited from aqueous or partially aqueous solutions. Moreover, the polymers can orient themselves with a majority of their hydrophilic, hydrogen-bonding groups towards the glass surface to provide sufficient adherence to the glass surface. Similarly, a majority of the hydrophobic groups may be oriented away from the surface to provide a low friction, low surface energy interface on the glass substrate.

The ratio or balance of hydrophobic to hydrophilic groups in a polymer may dictate the strength of attachment of the polymer to the glass surface and its corresponding resistance to unwanted removal by water. In one embodiment, polymers having a suitable hydrophobic/hydrophilic balance may have a diblock structure AB where A is a hydrophobic block and B is a hydrophilic block. The term “amphiphilic polymer” is also commonly used to describe such a polymeric structure. The hydrophilic B block(s) in the amphiphilic block copolymers may be prepared from different monomers, or oligomers, for example, monomers selected from acrylic acid, maleic acid, hydroxyethylmethacrylate (HEMA), polyethyleneglycol (meth)acrylate,ethoxypolyethyleneglycol (meth)acrylate, methoxyethyl (meth)acrylate, ethoxy (meth)acrylate, 2-dimethylamino-ethyl(meth)acrylate (DMAEMA), or combinations thereof. Likewise, exemplary hydrophobic A blocks of an amphiphilic block copolymer can be prepared from known hydrophobic monomers including, but not limited to, monovinyl aromatic monomers such as styrene and alpha-alkyllstyrenes, and other alkylated styrenes, or alkyl (meth)acrylic esters, or vinyl esters.

The hydrophobic and hydrophilic block may be respectively chosen to provide a balanced polymer which can be hydrophilic enough to adhere to the glass surface, but not so hydrophilic that it is has insufficient resistance to unwanted removal by water, as well as hydrophobic enough to serve as a barrier to particle adhesion, but not so hydrophobic so as to resist washing off with detergent. A non-limiting exemplary class of polymers may include, for instance, hydrophilic/hydrophobic copolymers of styrene and maleic acid (pSMA) and salts thereof, to name a few.

As such, according to various embodiments, the disclosure relates to glass substrates comprising at least one surface and a coating on at least a portion of the surface, wherein the coating comprises at least one polymer, wherein the coated portion of the surface has a contact angle with deionized water ranging from about 30 degrees to about 95 degrees, wherein after contact with water the coated portion has a contact angle of greater than about 30 degrees, and wherein after contact with a detergent solution the coated portion has a contact angle of less than about 10 degrees.

Silanes may also be used as surface-reactive treatment agents, for example, substituted alkyl silanes or bridged disilanes. A substituted alkyl silane is similar in structure to an alkyl siloxane referred to above with the exception that the alkyl is also substituted with one or more organic functional groups selected from the group consisting of amino, ammonium, hydroxyl, ether and carboxylic acid. In many instances, the substituted alkyl silane can be substituted with an organic functional group positioned at a terminal end of the alkyl group or anywhere along or within the alkyl chain. Also, in many instances the substituted alkyl may be a substituted lower alkyl. Some exemplary substituted lower alkyl silanes include, but are not limited to, γ-aminopropyltriethoxy silane, γ-aminopropytrimethoxy silane, β-aminoethyltriethoxy silane, and δ-aminobutyltriethoxy silane.

In some embodiments, substituted alkyl silanes may include one or more functional groups selected from the group consisting of quaternary nitrogen, ether and thioether. According to certain embodiments, the substituted alkyl silanes may include a pendant (C₆-C₃₀) alkyl that extends from the functional group, for example, substituted alkyl silanes with a quaternary nitrogen and having a pendant (C₁₀-C₂₄) alkyl group. Non-limiting exemplary substituted alkyl silanes can include, for instance, N,N-dimethyl-N-(3-(trimethoxysilyl)propyl)octadecan-1-ammonium chloride (“YSAM C18”), the chemical structure of which is indicated below. YSAM C14 and YSAM C1, respectively, are also represented below. YSAM C18 has a pendant (C₁₈)alkyl off a quaternary nitrogen. Likewise, YSAM C14 has a pendant (C₁₄)alkyl off a quaternary nitrogen.

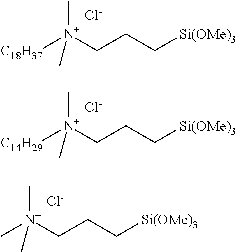

Bridged disilanes may be chosen from those having a general formula (I) as provided below:

(R²)₃Si—X—Si(R²)₃ I

wherein R² is a lower alkyl and X is NH or O. A class of bridged disilanes are referred to as disilazanes where X is NH.

Exemplary proprietary silane-based compounds may include, but not limited to, Virtubond™ and Pyrosil® available from Sura Instruments GmbH. According to various embodiments, the silanes may be water-soluble, thus allowing for deposition on the glass surface in an aqueous solution. In additional embodiments, the silanes may orient themselves with an outward (e.g., extending away from the glass) hydrophobic monolayer that may serve as a protective coating against particle adhesion. The silane may be further chosen such that it reacts with the glass surface and, thus, resists removal by and/or dissolution into water alone. In still further embodiments, the silane may be removed by application of an alkaline detergent solution and/or by an atmospheric plasma. For example, an RF plasma may be generated from atmospheric gases and this plasma may react with and decompose the silane coating into gaseous species or small molecules that can be washed off the glass surface. Silane coatings may also be removed by relatively more concentrated alkaline detergents and/or relatively higher temperatures, e.g., detergent solutions having a concentration as high as 20% by volume, for instance, ranging from about 10% to about 18% by volume, or from about 12% to about 15% by volume, and temperatures as high as 100° C., such as ranging from about 40° C. to about 90° C., from about 50° C. to about 80° C., or from about 60° C. to about 70° C., including all ranges and subranges therebetween.

As such, according to various embodiments, the disclosure relates to glass substrates comprising at least one surface and a coating on at least a portion of the surface, wherein the coating comprises at least one silane, wherein the coated portion of the surface has a contact angle with deionized water ranging from about 30 degrees to about 95 degrees, wherein after contact with water the coated portion has a contact angle of greater than about 30 degrees, and wherein after contact with a plasma or UV ozone the coated portion has a contact angle of less than about 10 degrees

As discussed above with respect to the methods disclosed herein, the coated substrates may be cleaned prior to use to remove the surface treatment layer. After cleaning, the contact angle of the previously coated surface (with deionized water) can be greatly reduced, e.g., to as low as 0 degrees. For instance, the contact angle (with deionized water) when coated can be as high as about 95 degrees and, after cleaning, the contact angle (with deionized water) can be less than about 10 degrees, such as less than about 9 degrees, less than about 8 degrees, less than about 7 degrees, less than about 6 degrees, less than about 5 degrees, less than about 4 degrees, less than about 3 degrees, less than about 2 degrees, or less than about 1 degree, e.g., ranging from about 1 degree to about 10 degrees, including all ranges and subranges therebetween. Cleaning may comprise, in various embodiments, wet cleaning, e.g., washing with a detergent solution, or dry cleaning, e.g., plasma or ozone cleaning methods as disclosed herein.

Furthermore, the surface treatment layer may, in some embodiments, exhibit a moderate resistance to removal by water alone, which can be useful if the coated substrate is to be subjected to various finishing steps, such as edge finishing or edge cleaning, before its end use. As such, in these embodiments, the contact angle of the coated surface (with deionized water), after contact with water (e.g., at a temperature ranging from about 25° C. to about 80° C. for a period of up to about 5 minutes), may be greater than about 20 degrees, such as greater than about 25, 30, 35, 40, 45, 50, 55, 60, 65, 70, 75, 80, 85, 90, or 95 degrees, e.g., ranging from about 20 to about 95 degrees, including all ranges and subranges therebetween. Of course, the treated glass substrates may or may not exhibit one or all of these properties but are still intended to fall within the scope of the instant disclosure.

Glass substrates and methods of the present disclosure may have at least one of a number of advantages over prior art substrates and methods. For example, methods disclosed herein may exhibit superior performance in terms of higher throughput, lower cost, and/or improved integratability, scalability, reliability, and or consistency as compared to prior art methods. Moreover, glass substrates treated according to such methods may have reduced particle adhesion, may be easier to clean, and/or may have improved performance over extended storage time periods. Furthermore, a reduction in the number of adhered glass particles may also provide a glass substrate with reduced scratching, e.g., due to a lower friction surface and reduced abrasive points of contact between the glass particles and the glass surface. Of course, it is to be understood that the substrates and methods disclosed herein may not have one or more of the above characteristics but are still intended to fall within the scope of the disclosure and appended claims.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a surface treatment agent” includes examples having two or more such surface treatment agents unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a structure or method that comprises A+B+C include embodiments where a structure or method consists of A+B+C and embodiments where a structure or method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

Contact Angle

Corning EAGLE XG® glass substrates were subjected to various surface treatments to evaluate the effect of each treatment on contact angle after coating, after contact with water, and after contact with a detergent solution. Glass samples were coated using different surface treatment agents and the contact angle of the surface-treated glass substrates with deionized water was measured. The substrates were then rinsed in room temperature deionized water for 60 seconds and the contact angle measured again. Finally, the substrates were washed with an 2% alkaline detergent at 50° C. for 60 seconds in an ultrasonic bath and the contact angle was measured once more. The results are illustrated in Table I below.

TABLE I
Contact Angle

| Surface Treatment | | | | Contact Angle (DIW) | | |
|---|---|---|---|---|---|---|
| | | | Conc. | As | After DIW | After Det. |
| Agent | Abbr. | Solvent | (wt %) | Coated | Wash | Wash |
| Polymers | | | | | | |
| Poly(styrene-co-maleic acid) | pSMA | IPA¹ | 1.5 | 89.4 | 88.3 | 3.5 |
| Poly(styrene-co-maleic | SMA | Water | 1-1.5 | 51.2 | 50.6 | 2.7 |
| acid)ammonium salt | N30 | | | | | |
| Poly(ethylene-co-acrylic acid) | pEAA | NMP² | 2 | 60.3 | — | 41.3 |
| Poly(ethylene-co-maleic acid) | pEMA | Water | 1.5 | 25.6 | 23.0 | 4.1 |
| Poly(4-vinylphenol)/poly-4- | PHS | IPA | 1.5 | 72.2 | 70.1 | 19.0 |
| hydroxystyrene | | | | | | |
| Poly(acrylic acid) | PAA | Water | 1.5 | 6.2 | 23.9 | 2.9 |
| Polyethyleneimine | PEI | Water | 0.1 | 4.4 | 11.8 | 3.4 |
| Poly(vinyl alcohol) | PVA | Water | 1 | 40.2 | 30.4 | 21.8 |
| Poly(ethylene-co-vinyl alcohol) | PEVA | NMP | 2 | 50.4 | 53.6 | 53.6 |
| Ethylcellulose | EC | NMP | 1 | 70.3 | 70.9 | 22.4 |
| Hydroxyelthylcellulose | HEC | Water | 0.5 | 17.1 | 27.6 | 33.9 |
| Carboxymethylcellulose | Na-CMC | Water | 0.5 | 10.5 | 4.4 | 3.7 |
| sodium salt | | | | | | |
| Surfactants | | | | | | |
| Hexyltrimethylammonium | HTAB | Water | 0.1 | 23.6 | 3.1 | 4.5 |
| bromide | | | | | | |
| Dicocoalkyldimethylammonium | Coco | Water | 0.1 | 83.0 | 82.5 | 6.0 |
| chloride | DMA | | | | | |
| Didecyldimethylammonium | DDAC | Water | 0.1 | 81.0 | 73.8 | 3.0 |
| chloride | | | | | | |
| Dodecyltrimethylammonium | DTAC | Water | 0.1 | 55.3 | 50.1 | 3.9 |
| chloride | | | | | | |
| Octadecyltrimethylammonium | OTAC | Water | 0.1 | 7.4 | 85.9 | 3.8 |
| chloride | | | | | | |
| Ethoxylated cocoamine | Eth C25 | Water | 0.1 | 50.1 | 58.4 | 3.1 |
| PEG/PPG copolymer non-ionic | Pluronic | Water | 2 | 22.0 | 24.4 | 8.2 |
| surfactant | F127 | | | | | |
| Fatty Alcohols | | | | | | |
| Octadecanol | octa-evap | None | 100 | 27.1 | — | 5.6 |
| Octadecanol | octa-IPA | IPA | <2 | 81.3 | 21.8 | 5.7 |
| Silanes | | | | | | |
| Fluoroalkyl silane | Aquapel | Naptha | <10 | 107.7 | 110.4 | 114.7 |
| Octadecyldimethyl(3- | YSAM | Water | <0.5 | 86.1 | 84.0 | 78.8 |
| trimethylsilylpropyl) ammonium | | | | | | |
| chloride | | | | | | |

¹IPA: isopropanol
²NMP: N-methyl-2-pyrrolidone

As demonstrated in Table I above, the glass samples coated with pSMA, SMA N30, PEAA, or PHS polymers exhibited a relatively high contact angle with deionized water after coating, indicating that the hydrophobicity, or resistance of the surface to water, was increased by the treatment. The water resistance of these treated samples was also demonstrated by the relatively high contact angle of the surface treated samples, even after washing with deionized water for 60 seconds (PEAA not measured). However, after contacting the treated glass substrates with a detergent for 60 seconds, the contact angle of the substrates decreased significantly in the case of pSMA and SMA N30, which tends to indicate that the surface treatment was successfully removed, but the PEAA and PHS treated samples retained a relatively high contact angle, indicating that they were not easily or efficiently removed. In some embodiments, a contact angle of less than about 20, less than about 10 degrees, or even less than about 5 degrees, can indicate a “clean” glass surface. The hydrophilic polymers (PVA, PEI, PAA, PEVA) and cellulose derivative polymers did not perform well, either due to an insufficiently high contact angle upon coating, an insufficiently high contact angle upon rinsing with water, or an insufficiently low contact angle upon washing with detergent.

Similarly, glass samples treated with cationic surfactants having a longer (e.g., C₈-C₃₀) alkyl chain (Coco DMA, DDAC, DTAC, OTAC) exhibited a relatively high contact angle with deionized water after coating, maintained a relatively high contact angle after rinsing with water, and exhibited a relatively low contact angle upon washing with detergent. In contrast, shorter chain cationic surfactants (HTAB) did not perform as well in comparison, particularly due to an insufficiently high contact angle upon rinsing with water. On the other hand, non-ionic surfactants (Eth C25, Pluronic F127) exhibited a relatively high contact angle with deionized water after coating, maintained a relatively high contact angle after rinsing with water, and exhibited a relatively low contact angle upon washing with detergent.

Finally, octadecanol, deposited both as a vapor and as a solution, exhibited a relatively high contact angle with deionized water after coating, maintained a sufficiently high contact angle after rinsing with water, and exhibited a relatively low contact angle upon washing with detergent. Two surface-reactive silane treatments (YSAM, Aquapel) were also evaluated. While these surface treatments exhibited high adhesion to the glass surface (as indicated by the contact angles both before and after rinsing with water), their covalent bonding with the glass surface also made these coatings rather difficult to remove by traditional wet washing methods (as indicated by the high contact angle after washing with detergent). However, these coatings may be removed by other methods, such as a higher temperature and/or higher concentration alkaline detergent wash and/or plasma removal methods.

Particle Adhesion

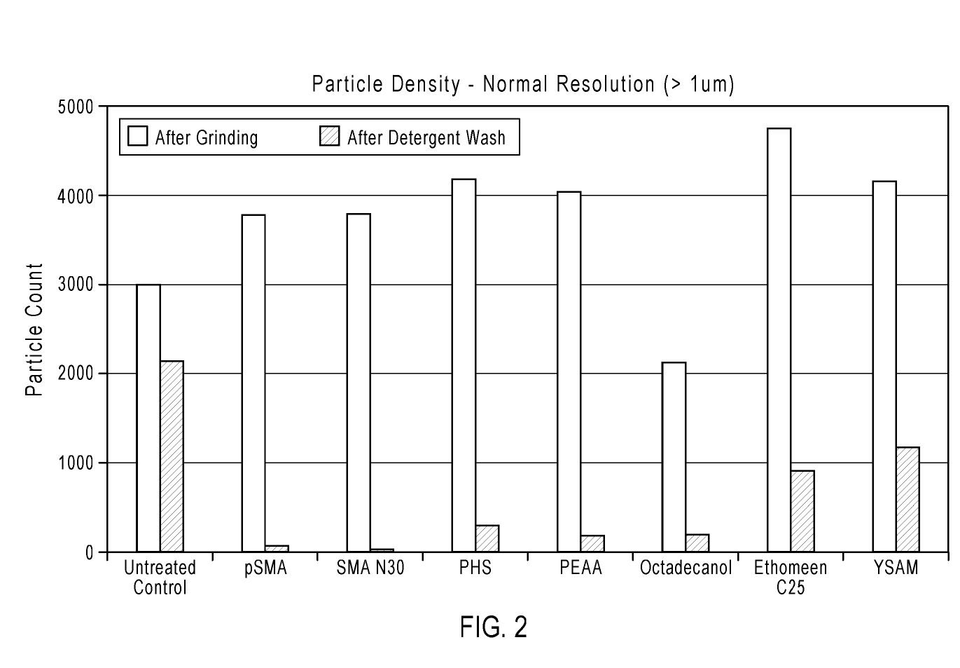

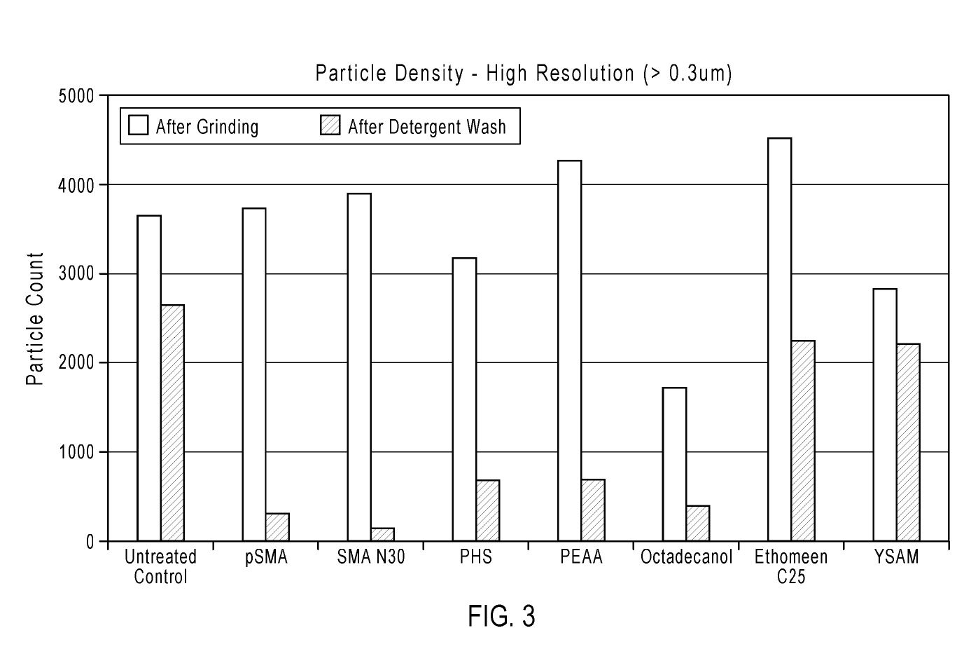

The surface treated glass samples, as well as untreated samples, were subjected to edge grinding and subsequent washing processes to assess the ability of the coatings to protect a glass surface from glass particle adhesion and/or to facilitate the removal of any adhered particles by washing. The edges of the glass samples (4″×4″) were ground in the presence of deionized water in a manner that generated glass particles which were flung onto the glass surface. The wet samples were air dried under a HEPA air filter in a vertical orientation. A Toray particle counter using a light scattering process was then used to count the number of particles deposited on the glass surface by the edge grinding process. The glass samples were then washed with a 2% alkaline detergent at 50° C. for 90 seconds in an ultrasonic bath. The particles remaining on the glass surface after washing were then re-counted. The results of these tests are presented in FIGS. 2-3. Normal resolution counts particles having a diameter greater than 1 μm, whereas high resolution counts smaller particles having a diameter as low as 0.3 μm.

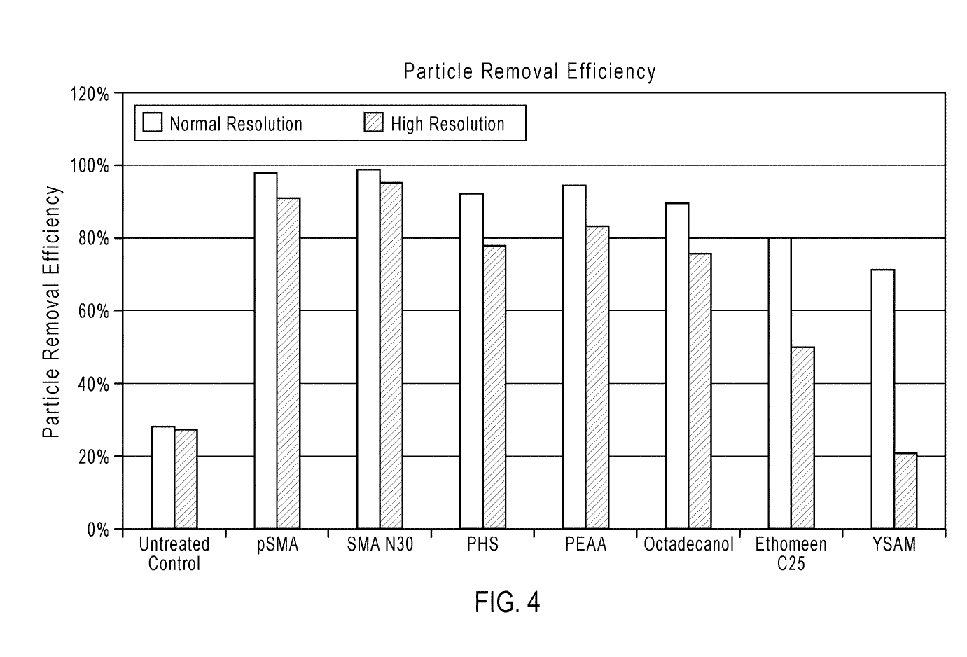

FIGS. 2-3 demonstrate substantially lower particle counts for all surface-treated glass after washing as compared to the untreated glass. Among the various treatments, it appears that the copolymer treatment agents (pSMA, SMA N30) outperformed the hydrophobic polymer (PHS) and fatty chain functional organic compound (octadecanol), which outperformed the surfactant (Eth C25). However, all of these surface treatments performed significantly better than the untreated sample. Referring to FIG. 4, which demonstrates particle removal efficiency after washing, it was again shown that the copolymer treatment agents (pSMA, SMA N30) outperformed the hydrophobic polymer (PHS) and fatty chain functional organic compound (octadecanol), which outperformed the surfactant (Eth C25). In all instances, the surface treated samples significantly outperformed the untreated sample.

What is claimed is:

1. A glass substrate comprising at least one surface and a coating on at least a portion of the surface, wherein:
a coated portion of the surface has a contact angle with deionized water ranging from about 20 degrees to about 95 degrees,
after contact with water the coated portion of the surface has a contact angle with deionized water of greater than about 20 degrees, and
after contact with a detergent solution the coated portion of the surface has a contact angle with deionized water of less than about 10 degrees.

2. The glass substrate of claim 1, wherein the coating has a thickness of less than about 1 μm.

3. The glass substrate of claim 1, wherein the coating has a thickness ranging from about 1 nm to about 100 nm.

4. The glass substrate of claim 1, wherein the coating comprises at least one surface treatment agent chosen from surfactants, polymers, fatty chain functional organic compounds, silanes, and combinations thereof.

5. The glass substrate of claim 1, wherein the coated portion of the surface has a surface energy of less than about 65 mJ/m².

6. The glass substrate of claim 1, wherein contact with water comprises contacting the glass substrate with water having a temperature ranging from 25° C. to about 80° C. for a time period of about 5 minutes or less.

7. The glass substrate of claim 6, wherein the glass substrate is contacted with room temperature water for about 60 seconds or less.

8. The glass substrate of claim 1, wherein contact with a detergent solution comprises contacting the glass substrate with the detergent solution having a temperature ranging from about 25° C. to about 80° C. for a time period of about 2 minutes or less.

9. The glass substrate of claim 8, wherein the glass substrate is contacted with an alkaline detergent solution for about 60 seconds or less.

10. A method for treating a glass substrate, comprising:
bringing a surface of the glass substrate into contact with at least one surface treatment agent for a residence time sufficient to form a coating on at least a portion of the surface, wherein:
a coated portion of the surface has a contact angle with deionized water ranging from about 20 degrees to about 95 degrees,
after contact with water the coated portion of the surface has a contact angle with deionized water of greater than about 20 degrees, and
after contact with a detergent solution the coated portion of the surface has a contact angle with deionized water of less than about 10 degrees.

11. The method of claim 10, wherein the at least one surface treatment agent is chosen from surfactants, polymers, fatty chain functional organic compounds, and combinations thereof.

12. The method of claim 10, wherein the at least one surface treatment agent is chosen from hydrophobic polymers, hydrophilic/hydrophobic copolymers, non-ionic surfactants, cationic surfactants comprising a (C₈-C₃₀)alkyl chain, fatty alcohols comprising a (C₆-C₃₀)alkyl chain, and combinations thereof.

13. The method of claim 10, wherein the coating has a thickness of less than about 1 μm.

14. The method of claim 10, wherein the coating has a thickness ranging from about 1 nm to about 100 nm.

15. The method of claim 10, wherein bringing the surface of the glass substrate into contact with the at least one surface treatment agent comprises dip coating, spin coating, spray coating, meniscus coating, flood coating, roller coating, brush coating, aerosol coating, vapor deposition, and combinations thereof.

16. The method of claim 10, wherein the surface of the glass substrate has a temperature of about 100° C. or less when contacted with the at least one surface treatment agent.

17. The method of claim 10, further comprising grinding an edge of the glass substrate.

18. The method of claim 17, wherein after grinding the coated portion of the glass substrate has a contact angle with deionized water of greater than about 20 degrees.

19. The method of claim 10, further comprising washing the glass substrate with a detergent solution.

20. The method of claim 19, wherein after washing the glass substrate has a contact angle with deionized water of less than about 10 degrees.

21. The method of claim 10, further comprising applying a polyethylene film to at least a portion of the surface of the glass substrate.

22. A glass substrate comprising at least one surface and a coating on at least a portion of the surface, wherein:
the coating comprises at least one polymer,
a coated portion of the surface has a contact angle with deionized water ranging from about 30 degrees to about 95 degrees,
after contact with water the coated portion of the surface has a contact angle with deionized water of greater than about 30 degrees, and
after contact with a detergent solution the coated portion of the surface has a contact angle with deionized water of less than about 10 degrees.

23. The glass substrate of claim 22, wherein the at least one polymer is chosen from block copolymers comprising styrene and maleic acid monomers, and salts thereof.

24. A glass substrate comprising at least one surface and a coating on at least a portion of the surface, wherein:
the coating comprises at least one silane,
a coated portion of the surface has a contact angle with deionized water ranging from about 20 degrees to about 95 degrees,
after contact with water the coated portion of the surface has a contact angle with deionized water of greater than about 20 degrees, and
after contact with plasma or UV ozone the coated portion of the surface has a contact angle with deionized water of less than about 10 degrees.

25. The glass substrate of claim 24, wherein the at least one silane is chosen from substituted alkyl silanes comprising a quaternary nitrogen and a pendant (C₁₀-C₂₄) alkyl group.
